(19) United States
(12) Patent Application Publication
(10) Pub. No.: US 2025/0368103 A1
(43) Pub. Date: Dec. 4, 2025

(54) CONVECTIVE/CONDUCTIVE SEAT VENTILATION

(71) Applicant: Toyota Motor Engineering & Manufacturing North America, Inc., Plano, TX (US)

(72) Inventors: John D. Harkleroad, Ypsilanti, MI (US); Vasudeva S. Murthy, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/731,678

(22) Filed: Jun. 3, 2024

(51) Int. Cl. B60N 2/56

(52) U.S. Cl. CPC B60N 2/5642; B60N 2/5678; B60N 2210/30

(57) ABSTRACT

A seat can provide improved ventilation to a seat occupant. The seat can have a seat body including a core and an outer cover defining an outer surface of the seat. A flow passage can be defined in the seat body. The flow passage can include an opening defined in the outer cover. The portion of the seat body including the opening can be caused to move away from a seat occupant. Thus, convective cooling can be provided to the seat occupant in a region corresponding to the portion.

### FIELD

The subject matter described herein relates in general to seats and, more particularly, to seats that provide ventilation to a seat occupant.

### BACKGROUND

A vehicle typically includes a plurality of seats. There are numerous vehicle seat designs. Vehicles seats can be contoured and/or can include features to provide support and comfort to a vehicle occupant. Some vehicle seats can include various ergonomic features to enhance user comfort. Some vehicle seats are powered and allow a user to adjust one or more aspects of the seat.

### SUMMARY

In one respect, the present disclosure is directed to a seat. The seat can include a seat body. The seat body can include a core and an outer cover. The outer cover can define an outer surface of the seat. A flow passage can be defined in the seat body. The flow passage can include an opening defined in the outer cover. An actuator can be operatively connected to the seat body to cause a portion of the outer cover including the opening to move away from a seat occupant. In this way, convective cooling can be provided to a seat occupant in a region corresponding to the portion.

In another respect, the present disclosure is directed to a method of ventilating a seat. The seat can include a seat body. The seat body can include a core and an outer cover. The outer cover can define an outer surface of the seat. A flow passage can be defined in the seat body. The flow passage can include an opening defined in the outer cover. The method can include causing a portion of the outer cover including the opening to move away from a seat occupant. Thus, convective cooling is provided to the seat occupant in a region corresponding to the portion.

### BRIEF DESCRIPTION OF THE DRAWINGS

FIG. 1 is an example of a seat configured for convective/conductive ventilation.

FIG. 2 is an example of a system.

FIG. 3 is a cross-sectional view of a portion of the seat of FIG. 1, showing a configuration in which one or more actuators are non-activated.

FIG. 4 is a cross-sectional view of a portion of the seat of FIG. 1, showing a configuration in which the one or more actuators are activated.

FIG. 5 is an example of a seat providing convective/conductive ventilation to a seat occupant.

FIG. 6 is an example of a method of ventilating a seat.

### DETAILED DESCRIPTION

Some vehicle seats may provide ventilation to a seat occupant by attempting to push or pull air to cool the occupant. However, these seat ventilation systems struggle to effectively cool the seat occupant because the occupant's body blocks the airflow. With portions of the seat blocked, the air flows through the path of least resistance, such as those areas where the seat occupant is not in contact with the seat (e.g., at the upper shoulders and between the legs of the seat occupant). Consequently, the areas of contact between a seat occupant's body and the seat are insufficiently cooled.

According to arrangements described herein a seat can be configured to provide convective and conductive cooling to a seat occupant. The seat can include a seat body, which can include a core and an outer cover defining an outer surface of the seat. A flow passage can be defined in the seat body. The flow passage can include an opening defined in the outer cover. An actuator can be operatively connected to the seat body to cause a portion of the outer cover including the opening to move away from a seat occupant. In this way, convective cooling can be provided to a seat occupant by the opening. In some instances, the actuator can cause the portion of the outer cover to move toward the seat occupant such that the portion of the outer cover contacts the seat occupant. Thus, conductive cooling is provided to the seat occupant.

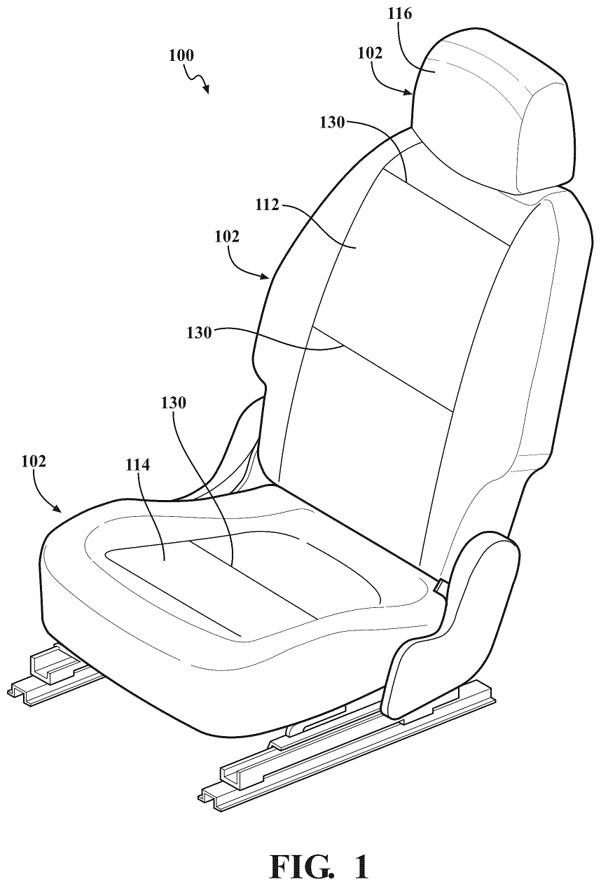

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example of a seat 100 is shown. In one or more arrangements, the seat 100 can be a vehicle seat. The seat 100 can be any type of vehicle seat, now known or later developed. The seat 100 can be for any vehicle occupants, such for a driver and/or for a passenger. As used herein, “vehicle” means any form of transport, including motorized or powered transport. In one or more implementations, the vehicle can be an automobile. While arrangements will be described herein with respect to automobiles, it will be understood that embodiments are not limited to automobiles. In some implementations, the vehicle may be a watercraft, an aircraft, spacecraft, or any other form of transport.

The seat 100 will be described herein with respect to a vehicle seat, but it will be appreciated that arrangements are not limited to vehicle seats. Indeed, the seat 100 can be an office chair, a chair, a massage chair, a gaming chair, a theater seat, a movie theater seat, a sports stadium seat, an entertainment venue seat, a recliner, a wheelchair, a sofa, a couch, a stool, or any other seat structure, now known or later developed.

The seat 100 can have any suitable configuration. For instance, the seat 100 can include a back portion 112 and a seat portion 114. In some arrangements, the back portion 112 and/or the seat portion 114 can include bolsters. In some arrangements, the seat 100 can include a headrest 116 and/or arm rests.

The seat 100 can have a seat body 102. The seat body 102 can have any suitable construction. For instance, the seat body 102 can include an outer cover 120 and a core 125, as shown in FIG. 4 (cross-sectional view of a portion of the seat 100). The outer cover 120 can cover the core 125. The outer cover 120 may also be referred to as trim. The outer cover 120 can define one or more exterior surface of the seat body 102.

The outer cover 120 can be made of any type of material, now known or later developed. In some arrangements, the outer cover 120 can be leather, synthetic leather, vegan leather, polyvinyl chloride (PVC), or fabric. The outer cover 120 can be made of any material(s) that can be effectively cooled according to arrangements described herein.

The core 125 can be made of any type of material, now known or later developed. In some arrangements, the core 125 can be made of foam. As an example, the core 125 can be made of polyurethane foam.

The outer cover 120 can cover at least a portion of the core 125. The outer cover 120 can be operatively connected to the core 125 in any suitable manner, now known or later developed. In some arrangements, the outer cover 120 can be operatively connected to the core 125 by one or more adhesives. Alternatively or additionally, the outer cover 120 can be operatively connected to the core 125 by one or more stitches. Alternatively or additionally, the outer cover 120 can be operatively connected to the core 125 by one or more fasteners. As an example, a portion of the outer cover 120 can be operatively connected to a portion of the core 125 by a hog ring or other suitable fastener. The portion of the outer cover 120 can include a reinforcing member, such as a wire or bead. Likewise, the portion of the core 125 can include a reinforcing member, such as a wire or bead. In at least some areas, the operative connection between the outer cover 120 and the core 125 can define a seam 130.

The seat 100 can be configured to provide cooling and/or ventilation to a seat occupant in any manner, now known or later developed. As an example, the seat 100 can include a plurality of flow passages 150. The flow passages 150 can pass through the seat body 102. For instance, the flow passages 150 can pass through the core 125 and the outer cover 120. Each flow passage 150 can define an opening 155 in the outer cover 120.

The flow passages 150 can be provided in the back portion 112, the seat portion 114, the bolster(s), the headrest 116, the arm rest(s), or any combination thereof. The flow passages 150 can be arranged in any suitable manner. For instance, the flow passages 150 can be arranged in rows and/or columns. In some arrangements, the flow passages 150 can be substantially equally spaced from each other. In some arrangements, the flow passages 150 can be randomly distributed. In some arrangements, the flow passages 150 can be provided in a plurality of regions or zones of the seat 100.

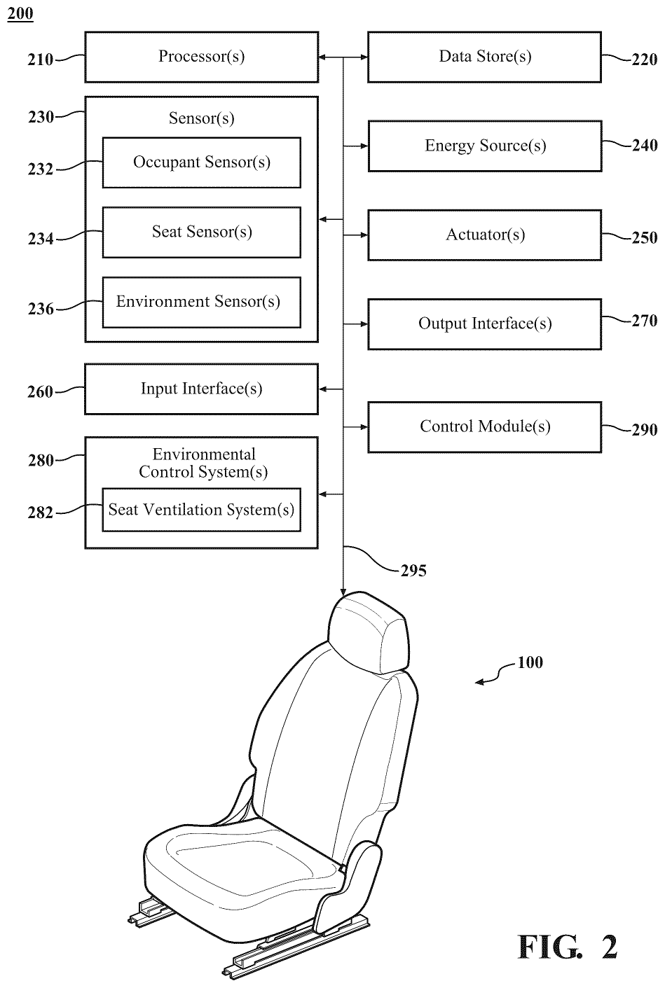

In some arrangements, a seat ventilation system 282 (see FIG. 2) can be configured to route or push air (or other coolant) through the flow passages 150 so that the air is exhausted through the respective openings 155 in the outer cover 120. In such case, the openings 155 can be exit openings. In some arrangements, the air can be sourced from the ambient air of the environment in which the seat 100 is located, such as the ambient air in a cabin of a vehicle. In some arrangements, the air can be sourced from the environmental control system(s) 280 (see FIG. 2), which can be, for example, the heating, ventilation, and/or air conditioning (HVAC) system of a vehicle. For instance, there can be one or more ducts to route air from an HVAC system to the flow passages 150.

In other arrangements, the seat ventilation system 282 can be configured to draw or pull air (or other coolant) into the flow passages 150 through the openings 155. In such case, the air can be exhausted from the flow passages 150 in any suitable location, such as a bottom of the seat 100. In such case, the openings 155 can be inlet openings. In some arrangements, the air can be sourced from the ambient air of the environment in which the seat 100 is located, such as the ambient air in a cabin of a vehicle. In some arrangements, the air can be sourced from the environmental control system(s) 280 (see FIG. 2), which can be, for example, the heating, ventilation, and/or air conditioning (HVAC) system of a vehicle. For instance, there can be one or more ducts to route air from an HVAC system to the flow passages 150.

The seat 100 can include one or more actuators 250 (see FIGS. 2-4). The actuator(s) 250 can be operatively positioned relative to one or more surfaces or portions of the seat 100. The actuator(s) 250 can be operatively positioned in those areas of the seat 100 that include the flow passages 150. In some arrangements, the actuator(s) 250 can be located within the seat 100, such as within the core 125 and/or the outer cover 120. In some arrangements, the actuator(s) 250 can be at least partially located external to the seat 100.

The actuator(s) 250 can be operatively connected to one or more portions of the seat 100. For instance, the actuator(s) 250 can be connected to one or more fixed structures and to one or more structures that can be moved by the actuator. As an example, the actuator(s) 250 can be operatively connected to the seat body 102, such as to the core 125 and/or the outer cover 120. In one or more arrangements, the actuator(s) 250 can be operatively connected to the seat body 102 at the seam 130. In some arrangements, the actuator(s) 250 can be operatively connected to a frame of the seat 100, which can be considered to be a fixed structure. The fixed structure can anchor the actuator(s) 250.

The actuator(s) 250 can be configured to cause a portion of the seat body 102 including the opening 155 to move away from a seat occupant. The actuator(s) 250 can be configured to cause the portion of the seat body 102 to move toward the seat occupant such that the portion of the seat body 102 contacts the seat occupant. Additional details of the actuator(s) 250 will be explained later in this disclosure.

Referring to FIG. 2, an example of a system 200 for ventilation of the seat 100 is shown. The system 200 can include various elements. Some of the possible elements of the system 200 are shown in FIG. 2 and will now be described. It will be understood that it is not necessary for the system 200 to have all of the elements shown in FIG. 2 or described herein. The system 200 can have any combination of the various elements shown in FIG. 2. Further, the system 200 can have additional elements to those shown in FIG. 2. In some arrangements, the system 200 may not include one or more of the elements shown in FIG. 2.

In the context of a vehicle, the various elements of the system 200 may be located on or within a vehicle; however, it will be understood that one or more of these elements can be located external to the vehicle. Thus, such elements are not located on, within, or otherwise carried by the vehicle. Further, the elements shown may be physically separated by large distances. Indeed, one or more of the elements can be located remote from the vehicle, such an on a remote server or cloud-based server.

In addition to the seat 100, the system 200 can include one or more processors 210, one or more data stores 220, one or more sensors 230, one or more energy sources 240, one or more actuators 250, one or more input interfaces 260, one or more output interfaces 270, one or more environmental control systems 280, and/or one or more control modules 290.

The various elements of the system 200 can be communicatively linked to one another or one or more other elements through one or more communication networks 295. As used herein, the term “communicatively linked” can include direct or indirect connections through a communication channel, bus, pathway or another component or system. A “communication network” means one or more components designed to transmit and/or receive information from one source to another. The data store(s) 220 and/or one or more other elements of the system 200 can include and/or execute suitable communication software, which enables the various elements to communicate with each other through the communication network and perform the functions disclosed herein.

The one or more communication networks 295 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

The various potential elements of the system 200 will be described in turn below. As noted above, the system 200 can include one or more processors 210. “Processor” means any component or group of components that are configured to execute any of the processes described herein or any form of instructions to carry out such processes or cause such processes to be performed. The processor(s) 210 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 210 can include at least one hardware circuit (e.g., an integrated circuit) configured to carry out instructions contained in program code. In arrangements in which there is a plurality of processors 210, such processors can work independently from each other or one or more processors can work in combination with each other.

The system 200 can include one or more data stores 220 for storing one or more types of data. The data store(s) 220 can include volatile and/or non-volatile memory. Examples of suitable data stores 220 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 220 can be a component of the processor(s) 210, or the data store(s) 220 can be operatively connected to the processor(s) 210 for use thereby. The term “operatively connected,” as used throughout this description, can include direct or indirect connections, including connections without direct physical contact.

In some arrangements, the data store(s) 220 can store one or more actuation profiles. The actuation profile(s) can include instructions for activating the actuator(s) 250 in a specified manner. The actuation profile(s) can include activation patterns, activation sequences, activation zones, activation regions, activation times, activation of individual actuators or groups of actuators, etc. The actuation profile(s) can be created by an end user, a seat manufacturer, a vehicle manufacturer, or some other entity (e.g., such as a wellness or medical provider, service, or business). In some instances, one or more actuation profile(s) can be received from a remote source. In some arrangements, one or more actuation profile(s) can be associated with a particular health condition or state or context of a seat occupant.

In one or more arrangements, the data store(s) 220 can store user data. The user data can include user preferences with respect to the actuator(s) 250. Such preferences can include likes and/or dislikes about a particular actuation profile or a portion of an actuation profile. Such preferences can include preferred strength, duration, areas, timing, patterns, and/or other factors with respect to the actuators 250. The preferences can include areas to avoid. The user data can include a user's actuation profile usage history.

In one or more arrangements, the data store(s) 220 can store user health data. The user health data can include conditions, symptoms, diagnoses, treatment, etc. The user health data may be general health-related data and/or with respect to a particular user. In one or more arrangements, the data store(s) can store health thresholds, profiles, and/or preferences. In one or more arrangements, the data store(s) 220 can store user biodata or user health data acquired by one or more elements of the system 200. The user health data can include base line heath characteristics for a user, such as a baseline heart rate, pulse, temperature, perspiration amount, etc.

The system 200 can include one or more sensors 230. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process. These sensor(s) 230 can be configured to acquire sensor data.

In arrangements in which the system 200 includes a plurality of sensors 230, the sensors can work independently from each other. Alternatively, two or more of the sensors can work in combination with each other. In such case, the two or more sensors can form a sensor network. The sensor(s) 230 can be operatively connected to the processor(s) 210, the data store(s) 220, and/or other elements of the system 200 (including any of the elements shown in FIG. 1).

The sensor(s) 230 can include any suitable type of sensor, now known or later developed. The sensors(s) 230 can include one or more seat occupant sensors 232, one or more seat sensor(s) 234, and/or one or more environment sensor(s) 236. Each of these example types of sensors will be described in turn below.

The sensor(s) 230 can include one or more seat occupant sensors 232. In some arrangements, the seat occupant sensor(s) 232 can be configured to acquire data about a person sitting in the seat 100. In some arrangements, the seat occupant sensor(s) 232 can be configured to detect the presence of a seat occupant. In some arrangements, the seat occupant sensor(s) 232 can be configured to identify the occupant of the seat. The seat occupant sensor(s) 232 can include one or more cameras, one or more weight sensors, one or more seat deformation sensors, one or more pressure sensors, one or more proximity sensors, one or more facial recognition sensors, and/or one or more biometric sensors, just to name a few possibilities. Data acquired using one or more of these sensors can be used to determine the presence of a seat occupant and/or identify the seat occupant in any suitable manner, now known or later developed.

In some arrangements, the seat occupant sensor(s) 232 can be configured to determine a physiological state of the seat occupant. The seat occupant sensor(s) 232 can include one or more biosensors, which can be configured to acquire biodata of a person sitting in the seat 100. Biodata can include any biological data, biomarkers, physiological data, and/or psychological data that can be analyzed to determine a state or condition of a user, such as a comfort level or a health condition. Non-limiting examples of the biodata can include temperature, perspiration, blood pressure, heart rate, galvanic skin response (to measure degrees of arousal), sodium and potassium (to measure dehydration), among others. In some arrangements, the biosensor(s) can be configured to acquire biodata by direct contact with a body portion of a human being, such as a portion of a human's hand, finger, or thumb. The biodata acquired using one or more of the seat occupant sensor(s) 232 can be used to determine a state or condition of the seat occupant in any suitable manner, now known or later developed.

The sensor(s) 230 can include one or more seat sensor(s) 234. The seat sensor(s) 234 can be configured to acquire data about the seat 100 or any portion thereof. In some arrangements, the seat sensor(s) 234 can be configured to acquire information about a temperature of the seat 100, such as a temperature of the outer cover 120 of the seat. The temperature can be measured at one or more locations on the seat 100. In some arrangements, the temperature can be measured in those areas of contact between the seat occupant and the outer cover 120. The temperature can be measured in one or more locations of the seat portion 114, one or more locations of the back portion 112, one or more locations of the headrest 116, one or more locations of the bolsters, and/or one or more locations of the armrests. In some arrangements, the seat sensor(s) 234 can be configured to detect and acquire data about the areas of contact between the seat occupant and the seat 100. In such case, the seat sensor(s) 234 can include, for example, pressure sensors and/or proximity sensors. In some arrangements, the seat sensor(s) 234 can be configured to measure or otherwise acquire information about a flow rate in the flow passages 150. A low flow rate (either on an absolute scale or relative to the flow rate in other flow passages 150) can indicate blockage of the opening 155 by the seat occupant.

The sensor(s) 230 can include one or more environment sensors 236. The environment sensor(s) 236 can be configured to detect, determine, assess, monitor, measure, quantify and/or sense information about an environment in which the seat 100 is located. When the seat 100 is located within a vehicle, the environment sensor(s) 236 can include one or more sensor(s) to measure a temperature of a cabin of the vehicle. In one or more arrangements, the environment sensor(s) 236 can be configured to measure humidity within the cabin of the vehicle. In some arrangements, the environment sensor(s) 236 can be configured to measure weather conditions external to the vehicle, such as temperature and/or humidity.

As noted above, the system 200 can include one or more energy sources 240. The energy source(s) 240 can be any power source capable of and/or configured to energize or activate the actuator(s) 250. For example, the energy source(s) 240 can include one or more batteries, one or more fuel cells, one or more generators, one or more alternators, one or more solar cells, one or more heat sources, one or more electrical energy sources, other energy sources, and any combination thereof. The energy source(s) 240 can be operatively connected to supply energy to the actuator(s) 250.

The system 200 can include one or more actuators 250. The actuator(s) 250 can be any element or combination of elements operable to modify, adjust and/or alter one or more surfaces or portions of the seat 100. More particularly, the actuator(s) 250 can be configured to cause one or more portions of the seat 100 to be moved away from a seat occupant and to be moved toward a seat occupant.

It will be understood that the actuator(s) 250 can be any suitable type of actuator, now known or later developed. The actuator(s) 250 can include pneumatic actuators, hydraulic actuators, electrotechnical actuators, and/or piezoelectric actuators, just to name a few possibilities. The actuator(s) 250 can include piston(s), push and/or pull bar(s) or rod(s), linkage(s), slider(s), pulley(s), gear(s), gear track(s), motor(s), magnet(s), micro-electromechanical systems (MEMS), and/or combinations thereof, just to name a few possibilities.

In some arrangements, the actuator(s) 250 can include one or more contracting members. The contracting member(s) can be any structure that, when activated, is configured to shrink in length. In one or more arrangements, the contracting member(s) can be made of an active material. For instance, the contracting member(s) can be one or more shape memory material members. The phrase “shape memory material” includes materials that change shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members can be shape memory material wires. As an example, the shape memory material members can be shape memory alloy wires. Thus, when an activation input (e.g., heat, energy, etc.) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires.

In some instances, arrangements can provide for cooling of the shape memory alloy wire(s), if desired, to facilitate the return of the wire(s) to a non-activated configuration. Such cooling can be provided by the seat ventilation described herein. For instance, the shape memory alloy wire(s) can be routed at least partially within, adjacent to, or proximate to the flow passages 150. In some arrangements, the flow passages 150 can include apertures to allow a portion of the air to exit the flow passages 150 and heat exchanging engagement with the shape memory alloy wire(s).

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature TSMA. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material member(s) are described, in some implementations, as being wires, it will be understood that the shape memory material member(s) are not limited to being wires. Indeed, it is envisioned that suitable shape memory materials may be employed in a variety of other forms, such as sheets, plates, panels, strips, cables, tubes, or combinations thereof. In some arrangements, the shape memory material member(s) may include an insulating coating or an insulating sleeve over at least a portion of their length.

In some arrangements, the shape memory material member(s) can be operatively connected to different portions of the seat 100. In one or more arrangements, one portion of the shape memory material member(s) can be operatively connected to a seat frame or other fixed structure of the seat 100, and another portion of the shape memory material member(s) can be operatively connected to the outer cover 120 and/or the core 125, such as at one of the seams 130. Thus, when activated, the shape memory material member(s) can contract, thereby causing the outer cover 120 and/or the core 125 to be pulled toward the frame or other fixed structure of the seat 100. When the activation input to the shape memory material member(s) is discontinued, the shape memory material member(s) can relax and substantially return to a non-activated configuration.

In some arrangements, the actuator 250 can be a single actuator associated with the seat 100. In some arrangements, there can be the actuator 250 can be a plurality of actuators associated with the seat 100. The actuator(s) 250 can be operatively connected to one or more portions of the seat 100. In one or more arrangements, the actuator(s) 250 can be located within a portion of the seat 100. For instance, the actuator(s) 250 can be located within the back portion 112, the seat portion 114, the bolster of the back portion 112, the bolster of the seat portion 114, the headrest 116, one or more arm rests, or any combination or subset thereof. The actuator(s) 250 can be configured to cause a portion of the outer cover 120 and/or the core 125 of the seat 100 to move away from the seat occupant. The actuator(s) 250 can also be configured to cause the portion of the outer cover 120 and/or the core 125 of the seat 100 to move toward the seat occupant. The portion of the outer cover 120 and/or the core 125 of the seat 100 that is moved can include one or more of the openings 155.

In arrangements in which there is a plurality of actuators 250, the plurality of actuators 250 can be substantially identical to each other. Alternatively, one or more of the actuators 250 can be different from the other actuators 250 in one or more respects, such as size, shape, configuration, actuation effect, etc. The plurality of actuators 250 can be distributed in any suitable manner with respect to the relevant portion of the seat 100. In some instances, the plurality of actuators 250 can be arranged in one or more rows and/or one or more columns. In some instances, the plurality of actuators 250 can be arranged in a plurality of discrete areas, which may or may not be spaced apart.

The system 200 can include one or more input interfaces 260. An “input interface” includes any device, component, system, element or arrangement or groups thereof that enable information/data to be entered into a machine. The input interface(s) 260 can receive an input from a person (e.g., a vehicle occupant). Any suitable input interface 260 can be used, including, for example, a keypad, gesture recognition interface, voice recognition interface, display, touch screen, multi-touch screen, button, joystick, mouse, trackball, microphone and/or combinations thereof.

The system 200 can include one or more output interfaces 270. An “output interface” includes any device, component, system, element or arrangement or groups thereof that enable information/data to be presented to a person (e.g., a vehicle occupant). The output interface(s) 270 can present information/data to a person. The output interface(s) 270 can include a display. Alternatively or in addition, the output interface(s) 270 may include an earphone and/or speaker. Some components of the system 200 may serve as both a component of the input interface(s) 260 and a component of the output interface(s) 270.

The system 200 can include one or more environmental control systems 280. The environmental control system(s) 280 can be configured to heat, cool, ventilate, and/or otherwise alter the environment in which the seat 100 is located, such as the cabin of a vehicle. The environmental control system(s) 280 can include an air conditioning (AC) system. The environmental control system(s) 280 can be a heating, ventilation, and air conditioning (HVAC) system. The environmental control system(s) 280 can be configured to allow for cooling and/or humidity control for at least a portion of the environment in which the seat 100 is located. The environmental control system(s) 280 can include one or more mechanisms, devices, elements, components, systems, and/or combination thereof, now known or later developed.

In one or more arrangements, the environmental control system(s) 280 can include one or more seat ventilation systems 282. The seat ventilation system(s) 282 can be configured to provide cooling or ventilation to the seat 100. The seat ventilation system(s) 282 can be part of the environmental control system(s) 280, or the seat ventilation system(s) 282 can be separate from the environmental control system(s) 280. In some arrangements, the seat ventilation system(s) 282 can be configured to draw or divert air or other coolant from the environmental control system(s) 280 for use in providing cooling or ventilation to the seat 100.

The seat ventilation system(s) 282 can be configured to provide seat cooling and/or ventilation in any suitable manner. As an example, the seat ventilation system(s) 282 can cause air to be forced through the flow passage 150 in the seat 100. The air can be supplied from any suitable source. The air can exit the flow passage 150 through the opening 155 in the outer cover 120. In other arrangements, the seat ventilation system(s) 282 can be configured to draw air into the opening 155. In such case, the air can enter the opening 155, travel through the flow passage 150, and exhaust at or near a different part of the seat 100, such as at or near the bottom of the seat 100. In some arrangements, the seat ventilation system(s) 282 can be selectively activated and/or deactivated by a user (e.g., a seat occupant), such as by using the input interface(s) 260. In some arrangements, the seat ventilation system(s) 282 can be activated and/or deactivated automatically based on one or more real-time factors or conditions (e.g., seat occupant detected, temperature in the environment (e.g., temperature within the vehicle cabin and/or temperature external to the vehicle), weather in the environment (e.g., weather external to the vehicle), humidity in the environment (e.g., humidity within the vehicle cabin and/or humidity external to the vehicle), temperature of the seat occupant, perspiration of the seat occupant, etc.)

The system 200 can include one or more modules, at least some of which will be described herein. The modules can be implemented as computer readable program code that, when executed by a processor, implements one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data stores 220 may contain such instructions. In some arrangements, the module(s) can be located remote from the other elements of the system 200.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 200 can include one or more control modules 290. The control module(s) 290 can include profiles and logic for controlling the actuator(s) 250. The control module(s) 290 can use profiles, parameters, or settings loaded into the control module(s) 290 and/or stored in the data store(s) 220, such as the actuation profiles. In some arrangements, the control module(s) 290 can be located remotely from the other elements of the system 200, such as on a remote server, a cloud-based server, or an edge server.

The control module(s) 290 can be configured to cause one or more of the actuator(s) 250 to be activated or deactivated. As used herein, “cause” or “causing” means to make, force, compel, direct, command, instruct, and/or enable an event or action to occur or at least be in a state where such event or action may occur, either in a direct or indirect manner. The control module(s) 290 can cause the actuators 250 to be selectively activated or deactivated in any suitable manner. For instance, when the actuators 250 include a shape memory material member, the shape memory material member can be heated by the Joule effect by passing electrical current through the shape memory material member. To that end, the control module(s) 290 can be configured to selectively permit, restrict, adjust, alter, and/or prevent the flow of electrical energy from the energy source(s) 240 (or any other form of energy from any other suitable source) to the one or more shape memory material members of the actuator(s) 250. The control module(s) 290 can be configured to send control signals or commands over the communication network(s) 295 to the shape memory material members or to other elements of the system 200.

The control module(s) 290 can be configured to cause the actuator(s) 250 to be activated or deactivated based on various events, conditions, inputs, or other factors. For instance, the control module(s) 290 can be configured to cause the actuator(s) 250 to be activated or deactivated based on a user input. A user can provide an input on the input interface(s) 260. The input can be a command to implement one of the actuation profiles. The input can be a command to activate or deactivate the actuator(s) 250 based on the previously used actuation profile or a default actuation profile, such as an actuation profile stored in the data store(s) 220. In some instances, the input can be a newly defined actuation profile.

By activation of the actuator(s) 250, the control module(s) 290 can be configured to cause the cause a portion of the seat body 102 including one or more of the openings 155 to move away from a seat occupant. As a result, a gap or space can be formed between the seat occupant and the outer cover 120 in a region corresponding to the portion, and the opening 155 is no longer blocked by the seat occupant's body. As a result, air (or other coolant) can exit the flow passage 150 through the opening 155, or air (or other coolant) can be drawn into the flow passage 150 through the opening 155. Thus, air (or other coolant) can move around the occupant in the gap or space formed between the seat occupant and the outer cover 120 in a region corresponding to the portion. In this way, convective cooling can be provided to a seat occupant in a region corresponding to the portion. The actuator(s) 250 can be configured to hold the portion in the moved away position for a period of time.

By deactivating the actuator(s) 250 (after actuation), the control module(s) 290 can be configured to cause the portion of the seat body 102 to move toward the seat occupant such that the outer cover 120 in the region corresponding to the portion contacts the seat occupant. It will be appreciated that, while the actuator(s) 250 are activated, the outer cover 120 can be cooled by the flow of air (or other coolant) in the gap or space formed between the seat occupant and the outer cover 120 in a region corresponding to the portion. Thus, when the seat body 102 returns to contact the seat occupant, conductive cooling is provided to the seat occupant in a region corresponding to the portion.

The activation and deactivation of the actuator(s) 250 by the control module(s) 290 can be based on various real-time factors. Non-limiting examples of such real-time factors can include vehicle cabin humidity, perspiration of a seat occupant (e.g., is the seat occupant sweating?), temperature in the vehicle cabin, temperature of the seat occupant, temperature of the outer cover 120, and weather conditions (temperature of the external environment of the vehicle, whether it is sunny, cloudy, rainy, etc.), and/or any combination thereof. Data about these factors can be acquired by the sensor(s) 230. The control module(s) 290 can be configured to analyze the acquired sensor data. The control module(s) can take into account other factors that may affect the climate of the cabin and/or the seat occupant, such as the color of clothing worn by the seat occupant and/or the color of the seat 100 (e.g., the color of the outer cover).

The portion of the seat 100 can be moved away from the seat occupant for any suitable duration. In some arrangements, the portion can be moved away for a fixed period of time. In some arrangements, the portion can be moved away for a period of time based on real-time conditions. For example, if it is determined that the seat occupant is still sweating in the region corresponding to the moved away portion, then the portion can be continued to be held in the moved away position for a longer period of time. However, if it is determined that the seat occupant is not sweating in the region corresponding to the moved away portion, then the portion can be caused to be moved back toward the seat occupant.

In some arrangements, the activation and deactivation of the actuator(s) 250 can be done in accordance with an actuation profile. In some arrangements, the activation and deactivation of the actuator(s) 250 can be performed based on user command. In some arrangements, the activation and deactivation of the actuator(s) 250 can be done periodically, irregularly, randomly.

The control module(s) 290 can be configured to track seat ventilation usage, including data about the vehicular, seat occupant, and/or environment conditions at the time of such usage. Such data can be stored in the data store(s) 220. In some arrangements, the control module(s) 290 can include machine learning based to recognize certain patterns of usage, conditions when used, etc. When such conditions are learned, the control module(s) 290 can be configured to automatically activate and deactivate the actuator(s) 250 when such conditions are detected.

In some arrangements, the control module(s) 290 can be configured to determine an appropriate action for the actuator(s) 250. The control module(s) 290 can be configured to do so in any suitable manner. For instance, the control module(s) 290 can analyze a user's actuation profile usage history, a user's preferences, user context data, or other user data. Based on these and/or other sources, the control module(s) 290 can select, create, or predict an actuation profile that may be suitable for the user.

In other arrangements, the control module(s) 290 can be configured to determine an appropriate action for the actuator(s) 250 based on a user's health state, condition, user context data or data. For instance, the control module(s) 290 can be configured to analyze data or information acquired by the sensor(s) 230 (e.g., the seat occupant sensor(s) 232) to select, create, or predict an actuation profile that may be suitable for the user.

In some arrangements, the control module(s) 290 can be configured to control the actuator(s) 250 based on data received from the environment sensor(s) 236. The control module(s) 290 can be configured to do so in any suitable manner. For instance, the control module(s) 290 can analyze the environmental data and/or the data from one or more vehicle systems(s) to select, create, or predict an actuation profile that may be suitable for the user. In some arrangements, the control module(s) 290 can be configured to select, create, or predict an actuation profile that may be suitable for the user using user data and the environmental data and/or the data from one or more vehicle systems(s).

In one or more arrangements, the control module(s) 290 can be configured to cause a suggestion to use the seat ventilation to be presented to the user if warranted based on one or more current conditions or factors. In one or more arrangements described herein, the control module(s) 290 can be configured to cause the output interface(s) 270 and/or other component of the system 200 to be activated to provide the suggestion. The suggestion can be presented in any suitable form (e.g., visual, audial, haptic, etc.). As an example, if the control module(s) 290 detect that the seat occupant is sweating but the seat ventilation system 282 is not activated, then the control module(s) 290 can cause a suggestion to use the seat ventilation system 282 to be presented to the seat occupant.

When there are a plurality of actuators 250, the actuators 250 can be arranged in regions or zones. The actuator(s) 250 can be selectively activated in one or more zones. The zones can be activated based on a user input, according to an actuation profile, or as determined by the control module(s) 290.

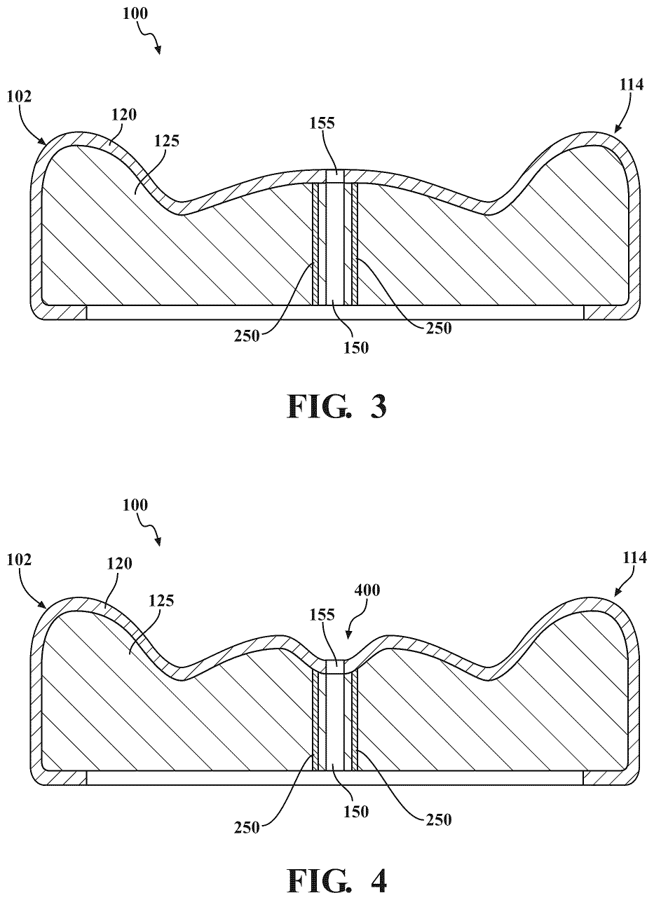

Referring to FIG. 3, a cross-sectional view of a portion of the seat of FIG. 1, showing a non-activated configuration. The seat 100 includes the outer cover 120 and the core 125. The flow passage 150 can extend through the core 125 and the outer cover 120. The flow passage 150 can define an opening 155 in the outer cover 120.

The flow passage 150 can have any suitable orientation. While FIG. 3 shows the flow passage 150 as extending substantially perpendicular to the horizontal direction in the orientation of FIG. 3, it will be appreciated that the flow passage 150 can extend at any suitable orientation. Further, the flow passage 150 can extends substantially straight, as shown in FIG. 3. However, it will be appreciated that the flow passage 150 can extend in a non-straight manner, either by one or more non-straight local features or being non-straight overall.

The flow passage 150 can have any suitable size, shape, and/or configuration. In one or more arrangements, the flow passages 150 can have a substantially circular cross-section shape.

While only a single flow passage is shown in FIG. 3, it will be appreciated that there can be a plurality of flow passages 150. The plurality of flow passages 150 can be substantially identical to each other. Alternatively, one or more of the flow passages 150 can be different from the other flow passages 150 in one or more respects.

One or more actuators 250 can be operatively positioned to cause a portion of the outer cover 120 to move away from a seat occupant. The portion can include one or more of the openings 155. In one or more arrangements, there can be a single opening 155 associated with the portion of the outer cover 120 that is moved away from the seat occupant. In one or more arrangements, there can be a plurality of openings 155 associated with the portion of the outer cover that is moved away from the seat occupant.

In this example, the actuators 250 can be operatively connected to the outer cover 120 and/or the core 125. In one or more arrangements, the actuators 250 can be operatively connected to both the outer cover 120 and the core 125, such as at one of the seams 130. In one or more arrangements, one or more of the actuators 250 can be operatively connected (e.g., at one end or end region region) to only the outer cover 120. In such case, the core 125 can be moved by the movement of the outer cover 120. In one or more arrangements, one or more of the actuators 250 can be operatively connected (e.g., at one end or end region region) to only the core 125. In such case, when the core 125 is moved away from the seat occupant, the outer cover 120 can move with the core 125. Another portion of the actuators 250, such as the opposite end or end region, can be operatively connected to a fixed structure, such as a frame of the seat 100.

It will be appreciated that, in the non-activated configuration, the outer cover 120 can contact the seat occupant. In such case, the openings 155 can be physically blocked by the body of the seat occupant.

FIG. 4 shows an example of an activated configuration of the actuator(s) 250. Here, the actuator(s) 250 have caused the outer cover 120 and/or the core to move away from a seat occupant. As a result, a gap or space 400 can be formed between the seat occupant and the outer cover 120. In such case, the opening 155 has moved away from the seat occupant. As a result, air can flow into and/or out of the space 400 through the opening 155. As a result, convective cooling can be provided to the seat occupant in the location of the space 400. The space 400 can have any suitable size, shape, and/or configuration. In some arrangements, the space 400 can be substantially conical.

The actuator(s) 250 can cause the outer cover 120 and/or the core 125 to move away from the seat occupant by pushing, pulling, or in other suitable manner. The outer cover 120 and/or the core 125 can be moved away any suitable distance from the seat occupant. The actuator(s) 250 can be configured to hold the outer cover 120 and/or the core 125 in the moved away position.

In some arrangements, the actuator(s) 250 can be configured to actively move the outer cover 120 and/or the core 125 toward the seat occupant. In such case, the actuator(s) 250 can push, pull, or otherwise move the outer cover 120 and/or the core 125. In some arrangements, the actuator(s) 250 can be configured to passively move the outer cover 120 and/or the core 125 toward the seat occupant. For instance, the actuator(s) 250 can be deactivated, thereby allowing the outer cover 120 and/or the core 125 to naturally move toward the seat occupant on their own. In some arrangements, the seat 100 can include one or more biasing members to facilitate the movement of the outer cover 120 and/or the core 125 toward the seat occupant.

It will be appreciated that, when the portion of the outer cover 120 and/or the core 125 return to their non-moved position, the outer cover 120 can directly contact the seat occupant in at least some areas of the portion. In some arrangements, the entire portion of the outer cover 120 can directly contact the seat occupant. The outer cover 120 can be cooled due to its exposure to the air (or coolant) while being moved away. As a result, the direct contact between the outer cover 120 and the seat occupant can cause conductive cooling to be provided to the seat occupant.

The portion of the seat body 102 that is moved away from and moved toward the seat occupant can have any suitable size, shape, and/or configuration. In some arrangements, the portion can be substantially circular, but other shapes are possible. In some arrangements, the portion can span the entire width of the seat or a majority of the width of the seat 100 or any portion of the seat 100 (e.g., the back portion 112, the seat portion 114, the headrest 116, the armrest, the bolster). In some arrangements, the portion can span the entire length of the seat or a majority of the length of the seat 100 or any portion of the seat 100 (e.g., the back portion 112, the seat portion 114, the headrest 116, the armrest, the bolster). In some arrangements, the portion of the seat body 102 that is moved away from and moved toward the seat occupant can be a localized area, as is shown in FIGS. 3 and 4.

Further, FIGS. 3 and 4 show an example in which there is single flow passage 150 associated with the portion of the seat body 102 that is moved away from and moved toward the seat occupant. In some arrangements, there can be a plurality of flow passages 150 associated with the portion of the seat body 102 that is moved away from and moved toward the seat occupant. The portions of the seat body 102 that are moved away from and moved toward the seat occupant will be referred to herein, for convenience, as the “moving portions.” In some arrangements, In some arrangements, the plurality of portions can be non-overlapping. In some arrangements, two or more of the portions can partially overlap each other.

FIGS. 3 and 4 show one moving portion of the seat body 102. However, it will be understood that, according to arrangements described herein, a plurality of moving portions of the seat body 102 can be provided. In such case, the plurality of moving portions can be moved away from and/or moved toward the seat occupant substantially simultaneously, sequentially, at different times, non-sequentially, or randomly. In some arrangements, one or more moving portions in only one portion (e.g., the back portion 112, the seat portion 114, the headrest 116, the armrest, the bolster) of the seat 100 can be activated. In some arrangements, one or more moving portions in a plurality of portion of the seat 100 can be activated.

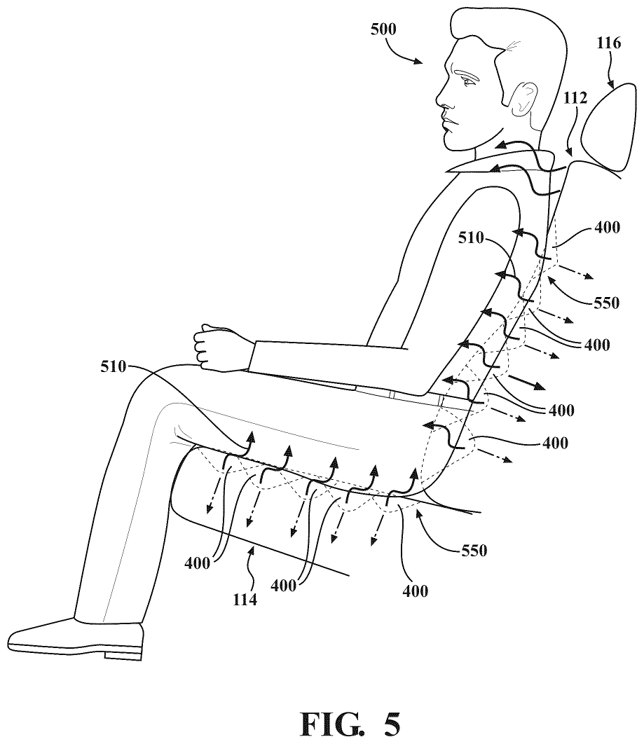

FIG. 5 is an example of the seat 100 providing convective/conductive ventilation to a seat occupant. A person can sit in the seat 100. The person will be referred to as the seat occupant 500. In this example, there can be a plurality of moving portions 550 of the seat body 102 that are moved away from and moved toward the seat occupant 500. In this example, eleven moving portions 550 are shown. However, it will be appreciated that there can be more regions or fewer moving portions 550.

FIG. 5 appears to show the moving portions 550 being substantially aligned in the back portion of the seat 100 and substantially aligned in the seat portion 114 of the seat 100. However, it will be appreciated that the moving portions 550 can be arranged in any suitable way. For instance, the moving portions 550 can be arranged in columns, rows, and/or in any other suitable way. The moving portions 550 can be substantially aligned with each other, or the locations can be offset from each other. Further, there can be additional moving portions 550 located into and/or out of the page in the view shown in FIG. 5.

In some arrangements, the moving portions 550 can be substantially identical in size, shape, and/or configuration. In other arrangements, one or more of the moving portions 550 can be different from the other locations in one or more respects, including any of these described herein.

FIG. 5 shows an example in which neighboring moving portions 550 overlap each other. However, it will be appreciated that, in other arrangements, the neighboring moving portions 550 are non-overlapping. Still further, it will be appreciated that some of the neighboring moving portions 550 can be overlapping and some of the neighboring moving portions 550 can be non-overlapping.

FIG. 5 shows the different moving portions 550 being located in the seat portion 114 and the back portion 112 of the seat 100. However, it will be appreciated that the moving portions 550 can be provided in the headrest 116 and/or armrests as well. In some arrangements, the seat portion 114 and/or the back portion 112 may not have the moving portions 550.

As described above, the actuators 250 can be activated in any suitable manner. FIG. 5 shows all of the moving portions 550 being activated at the same time. However, the actuators 250 associated with the moving portions 550 can be activated at different times. For instance, the actuators 250 can be activated sequentially (e.g., from the top down, from the bottom up, left to right, and/or right to left). In some arrangements, the actuators 250 can be activated in only certain regions of the seat 100. For instance, only the actuators 250 in the back portion 112 of the seat 100 can be activated (in any suitable manner) while the actuators 250 in the other portions of the seat 100 are not activated. In some arrangements, the different moving portions 550 can be activated in any sequence.

It will be appreciated that when the moving portions 550 of the seat 100 is moved away from the seat occupant 500, the openings 155 are not blocked. Thus, air 510 (or other coolant) can exit (or enter) the flow passage 150 through the opening 155. Thus, convective cooling can be provided to the seat occupant 500 in the regions corresponding to the moving portions 550. It will also be appreciated that the outer cover 120 of the moving portion 550 of the seat 100 can be ventilated and/or cooled by exposure to the movement of air 510 (or other coolant) in the space 400. Thus, when the moving portion is moved back toward the seat occupant 500 such that at least a portion of the outer cover 120 contacts the seat occupant 500, conductive cooling can be provided to the seat occupant 500 by the cooled outer cover 120.

Now that the various potential systems, devices, elements and/or components have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

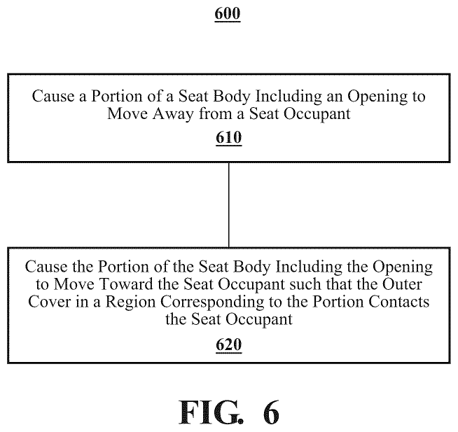

Turning to FIG. 6, an example of a method 600 of ventilation of a seat is shown. The seat 100 can include the seat body 102, which includes the core 125 and the outer cover 120. A flow passage 150 can be defined in the seat body 102. The flow passage 150 can include an opening 155 defined in the outer cover 120.

At block 610, a portion of the seat 100 (a moving portion) including the opening 155 can be caused to move away from the seat occupant. Such causing can be performed by the control module(s) 290, the processor(s) 210, and the actuator(s) 250. For instance, the actuator(s) 250 can be activated by the control module(s) 290 to move the portion of the seat 100 (e.g., the outer cover 120 and/or the core 125) away from the seat occupant. As a result, a space 400 can be formed between the seat occupant and the portion of the seat 100. Thus, the opening 155 can be spaced from the seat occupant, which allows air to exit the opening 155 or air to be drawn into the opening 155. As a result, convective cooling can be provided to the seat occupant in a region corresponding to the portion. It will be appreciated that the outer cover 120 of the portion of the seat 100 can be cooled as well while the portion is moved away from the seat occupant. The method 600 can continue to block 620.

At block 620, the portion of the seat 100 including the opening 155 can be caused to move toward the seat occupant such that at least a portion of the portion of the seat 100 contacts the seat occupant. Such causing can be performed by the control module(s) 290, the processor(s) 210, and the actuator(s) 250. For instance, the actuator(s) 250 can be activated by the control module(s) 290 to move the portion of the seat (e.g., the outer cover 120 and/or the core 125) toward the seat occupant. As a result, the space 400 can be closed, and the cooled outer cover 120 can contact the seat occupant. Thus, conductive cooling is provided to the seat occupant in the region corresponding to the portion.

The method 600 can end. Alternatively, the method 600 can return to block 610 or to some other block. The method 600 can be repeated at any suitable point, such as at a suitable time or upon the occurrence of any suitable event or condition.

It will be appreciated that the method 600 can include additional blocks. In some arrangements, the method 600 can be initiated automatically by the control module(s) 290, such as any time seat ventilation is activated. In some arrangements, the method 600 can be initiated or performed in response to a user command (e.g., provided on the input interface(s) 260). In some arrangements the method 600 can be initiated if one or more conditions are met based on sensor data acquired by the sensor(s) 230.

For instance, the method 600 can include determining whether the seat ventilation system 282 is active. Such a determination can be made by the control module(s) 290, the environmental control system(s) 280, the seat ventilation system(s) 282, the sensor(s) 230, the processor(s) 210, or any combination thereof. If seat ventilation system 282 is not active, then the method 600 can end, take no action, or continue to check whether the seat ventilation system 282 is active. If the seat ventilation system 282 is active, then the method 600 can proceed to block 610 or to some other block.

Alternatively or additionally, it can be determined whether a person is sitting in the seat 100. Such a determination can be made by the control module(s) 290, the sensor(s) 230 (e.g., the occupant sensor(s) 232), the processor(s) 210, or any combination thereof. If there is no seat occupant, then the method 600 can end, take no action, or continue to check whether the seat ventilation system 282 is active or whether there is a seat occupant. If there is a seat occupant, then the method 600 can proceed to block 610 or to some other block.

In some arrangements, the method 600 can be initiated based on a user command (e.g., provided on the input interface(s) 260). In some arrangements, the method 600 can be automatically initiated whenever the seat ventilation system 282 is activated and/or a seat occupant is detected. In some arrangements, the method 600 can be initiated automatically based on current conditions (e.g., one or more seat occupant conditions, one or more vehicle cabin conditions, and/or one or more seat conditions) using sensor data acquired by the sensor(s) 230.

In some arrangements, the method 600 can include repeating block 610 and block 620 in a different location of the seat 100. In some arrangements, the different location can be near, adjacent to, or overlapping with the initial location. In some arrangements, the method 600 can include performing block 610 and block 620 sequentially in a direction (e.g., up, down, left, right) of the seat 100. For instance, in the back portion 112 of the seat 100, block 610 and block 620 can be initially performed at or near the top of the back portion 112. Block 610 and block 620 can be repeated moving sequentially downward along the back portion 112. As a result, to the seat occupant 500, it can feel like a cold roller running down his or her back. In some cases, the block 610 and block 620 can next be performed in the seat portion 114 of the seat 100.

A non-limiting example of the operation of the arrangements described herein will now be presented in connection to FIG. 5. For purposes of this example, the seat 100 can be located in a vehicle. A person can sit in the seat 100. The person will be referred to as a seat occupant 500. The presence of the seat occupant 500 can be detected by the seat occupant sensor(s) 232. The seat occupant sensor(s) 232 can also acquire data about the seat occupant 500.

The seat ventilation system(s) 282 can be activated responsive to an input provided by the seat occupant 500, such as on the input interface(s) 260. Alternatively, the seat ventilation system(s) 282 can be activated automatically based on one or more current conditions (e.g., one or more seat occupant conditions, one or more vehicle cabin conditions, and/or one or more seat conditions) using sensor data acquired by the sensor(s) 230

When the seat ventilation system 282 is activated, air 510 can be supplied to the flow passages 150 in the seat 100. The air 510 can be supplied from any suitable source. The air 510 can be blocked or impeded from exiting the flow passages 150 due to the presence of the body of the seat occupant 500.

The control module(s) 290 can activate one or more of the actuators 250. In some instances, the activation of the actuators 250 can occur automatically whenever the seat ventilation system 282 is activated. In some instances, the activation of the actuators 250 can be based on a command, sensor data, condition, event, timer, or other factors. When activated, the actuator(s) 250 can cause a portion 550 of the seat body 102 (e.g., the outer cover 120 and the core 125) including the opening 155 to move away from a seat occupant 500. As a result, a gap or space 400 is formed. Thus, the opening 155 can be spaced from the seat occupant 500.

Air 510 can flow through the flow passage 150 and exit into the space 400 by the opening 155. The air 510 can provide convective cooling to the seat occupant 500 in a region corresponding to the portion 550. The air 510 can also cool the outer cover 120 of the portion 550. The control module(s) 290 can cause the portion 550 to be maintained in the moved away position for any suitable among of time.

The control module(s) 290 can cause the activated actuator(s) 250 to be deactivated or otherwise activated in a way to cause the portion 550 of the seat body 102 to move toward the seat occupant 500 such that the outer cover 120 in the region corresponding to the portion 550 contacts the seat occupant 500. As a result, the space 400 can disappear. The cooled outer cover 120 can provide conductive cooling to the seat occupant 500 in a region corresponding to the portion 550.

The above process of moving the portion 550 away from the seat occupant 500 and toward the seat occupant 500 can be repeated. While the above example describes action with respect to one of the portions 550, it will be appreciated that the same description applies to the other portions 550. Further, when there is a plurality of portions 550, the portions 550 can be activated independently of each other or in a coordinated manner. Still further, the portions 550 can be activated according to any sequence, pattern, zone, region, actuation profile, etc.

The moving the portion 550 away from the seat occupant 500 and toward the seat occupant 500 can continue for any suitable amount of time. For instance, it can continue until the seat ventilation system 282 is stopped. As another example, it can continue until a user provides a command to stop. As still another example, it can continue until a condition (e.g., the seat occupant 500 is no longer sweating) or event is detected based on sensor data acquired by the sensor(s) 230. The control module(s) 290 can cause the moving the portion 550 away from the seat occupant 500 and toward the seat occupant 500 to stop.

It will be appreciated that arrangements described herein can provide numerous benefits, including one or more of the benefits mentioned herein. For example, arrangements described herein can provide effective seat ventilation to a seat occupant. Arrangements described herein can provide a plurality of cooling modes to the seat occupant. Arrangements described herein can avoid issues with flow passages being blocks by the body of the seat occupant. Arrangements described herein enables flexibility in the areas or zones of the seat that are cooled. Arrangements described herein allow a seat occupant to create customized cooling profiles.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A seat comprising:
a seat body including a core and an outer cover defining an outer surface of the seat;
a flow passage defined in the seat body, the flow passage including an opening defined in the outer cover; and
an actuator operatively connected to the seat body to cause a portion of the seat body including the opening to move away from a seat occupant, whereby convective cooling is provided to a seat occupant in a region corresponding to the portion.

2. The seat of claim 1, wherein the actuator is configured to cause the portion of the seat body to move toward the seat occupant such that the outer cover in the region corresponding to the portion contacts the seat occupant, whereby conductive cooling is provided to the seat occupant in a region corresponding to the portion.

3. The seat of claim 1, wherein the seat body is one of a back portion, a seat portion, a headrest, an armrest, or a seat bolster.

4. The seat of claim 1, wherein the actuator is operatively connected to at least one of the core and the outer cover.

5. The seat of claim 1, wherein the actuator is operatively connected to a seam of the seat.

6. The seat of claim 1, further including one or more processors operatively connected to activate and deactivate the actuator.

7. The seat of claim 6, further including one or more energy sources operatively connected to supply energy to the actuator, wherein the one or more processors are operatively connected to the one or more energy sources, wherein the one or more processors are configured to selectively activate and deactivate the actuator by controlling a supply of energy from the one or more energy sources to the actuator.

8. The seat of claim 6, further including one or more sensors operatively connected to the one or more processors, wherein the one or more sensors are configured to acquire sensor data, and wherein the one or more processors are configured to selectively activate or deactivate the actuator based on the acquired sensor data.

9. The seat of claim 8, wherein the sensor data includes at least one of: a temperature of an external environment of a vehicle, a temperature within a cabin of the vehicle, a temperature of a seat occupant, and a temperature of the outer cover.

10. The seat of claim 1, wherein flow passage is a first flow passage, wherein the actuator is a first actuator, wherein the portion of the seat body is a first portion, and further including a second actuator operatively connected to the seat body to cause a second portion of the seat body including a second opening to move away from a seat occupant, whereby convective cooling is provided to a seat occupant in a region corresponding to the second portion.

11. The seat of claim 10, wherein the first actuator and the second actuator are independently activatable.

12. The seat of claim 10, wherein the first portion and the second portion are non-overlapping.

13. The seat of claim 1, wherein the seat is a vehicle seat.

14. The seat of claim 1, wherein the actuator is located within the seat body.

15. A method of ventilating a seat, the seat including a seat body including a core and an outer cover defining an outer surface of the seat, a flow passage being defined in the seat body, the flow passage including an opening defined in the outer cover, the method comprising:
causing a portion of the seat body including the opening to move away from a seat occupant, whereby convective cooling is provided to the seat occupant in a region corresponding to the portion.

16. The method of claim 15, further including:
causing the portion of the seat body including the opening to move toward the seat occupant such that the outer cover in the region corresponding to the portion contacts the seat occupant, whereby conductive cooling is provided to the seat occupant in the region corresponding to the portion.

17. The method of claim 15, wherein flow passage is a first flow passage, wherein the opening is a first opening, wherein the portion of the seat body is a first portion, wherein the seat includes a second flow passage defined in the seat body, the second flow passage including a second opening defined in the outer cover, the method further including:
causing a second portion of the seat body including the second opening to move away from the seat occupant, whereby convective cooling is provided to the seat occupant in a region corresponding to the second portion.

18. The method of claim 17, wherein causing the first portion of the seat body including the first opening to move away from a seat occupant and causing the second portion of the seat body including the second opening to move away from the seat occupant are performed at different times.

19. The method of claim 15, wherein causing the portion of the seat body including the opening to move away from a seat occupant is performed based on sensor data.

20. The method of claim 15, wherein causing the portion of the seat body including the opening to move away from a seat occupant is performed in response to a user command.
